(19) United States
(12) Patent Application Publication
(10) Pub. No.: US 2020/0183586 A1
(43) Pub. Date: Jun. 11, 2020

(54) APPARATUS AND METHOD FOR MAINTAINING DATA ON BLOCK-BASED DISTRIBUTED DATA STORAGE SYSTEM

(71) Applicant: YMAX Co., Ltd, Seoul (KR)

(72) Inventor: Gi Hong Yang, Incheon (KR)

(21) Appl. No.: 16/245,318

(22) Filed: Jan. 11, 2019

(30) Foreign Application Priority Data
Dec. 7, 2018 (KR) 10-20180156545

(51) Int. Cl. G06F 3/06; H04L 29/08; H04L 9/06

(52) U.S. Cl. CPC G06F 3/064; H04L 67/22; G06F 3/0604; G06F 3/067; H04L 9/0637

(57) ABSTRACT

The present invention relates to a block-chain-based distributed data storage apparatus and method, and more particularly, to provide a data management apparatus and method for a block-chain-based distributed data storage system, capable of maintaining stability and security of the block-chain technique by applying the block-chain technique to data storage, maximizing efficiency and stability of data storage in a data storage apparatus to which the block-chain technique is applied, being environmentally-friendly because it does not require an excessive computing source in a proof method for storing data, maximizing fairness of storage by providing compensation depending on a contribution level for data storage and managing data storage independently and autonomously without requiring any operator intervention.

### CROSS-REFERENCE TO RELATED APPLICATION

This application claims priority to and benefits of Korean Patent Application No. 10-2018-0156545 filed in the Korean Intellectual Property Office on Dec. 7, 2018, the entire contents of which are incorporated herein by reference.

### BACKGROUND OF THE INVENTION

### (a) Field of the Invention

The present invention relates to a data management apparatus and method for a distributed data storage system capable of storing a large amount of data based on a block chain. More specifically, a conventional method of storing data and storing a large amount of data has usually been used, but this method has a problem in security such as hacking a server or accessing a server to illegally extract data. When some issues occur in a server on which data is stored, the data may be lost, which leads to a problem in stability, if the data is not backed up separately by a user. The present invention relates to a data management apparatus and method for performing data management such as data input/output in a data storage system that is combined with a block chain technique having excellent security and stability to solve such problems of the conventional data storage apparatus.

### (b) Description of the Related Art

Recently, there is a growing need for storage devices that store large amounts of data, since not only the size of transmitted data has increased, but also data stored in a personal storage space such as a PC is stored in a cloud server connected to the Internet as a result of massive spread of smart phones and rapid penetration of high-speed Internet environment.

Cloud-based data storage is not limited to portals and communication service providers, but is becoming increasingly popular in groupware in the enterprise, and thus storage capacity of data storage devices is rapidly increasing and there is a growing need to improve the stability and security of data storage.

Recently, with the advent of various kinds of crypto currency, researches on a block chain technique have been actively carried out by combining encryption technique and block chain technique to enhance security and stability of crypto currency. The block chain technique, which is a kind of distributed data base technique, has excellent security and stability because it can distribute and store data to be stored in all node storages connected to a network such as the Internet such that integrity may be maintained through data stored in other node storages even when the security is broken through one node storage.

However, since the block chain technique stores same data in all node storages, there is a problem that the storage space is wasted due to redundancy of the data, and it is difficult to store a large amount of data due to transmission limit of the network.

In addition, a chain of blocks is formed by storing data to be stored in a block and connecting it with a previous block, and when a new block is connected to previous blocks, it is necessary to verify the validity of the new block and to agree on the validity of blocks to be connected between all the node storages connected to the network. As such, when a block is added, an agreement algorithm is required for all the node storages to verify the validity of the block to be added, and a typical agreement algorithm for ensuring the unity and validity of the block chain in this way includes proof-of-work and proof-of-stake. The proof-of-work verifies the validity of a transaction in a connection between the blocks, and deduces the problem to maintain the unity of the blocks, and in this process, excessive computing source is needed and the resource is wasted. The proof-of-stake does not waste computational sources and resources compared to the proof-of-work in the way of granting the right for generating new blocks depending on the stakes held by the node storages, but since a proportion of the block generation authority is changed depending on an amount of the shakes.

As described above, the conventional block chain verification method has a problem in fairness, environment friendliness, etc., and a data management method capable of enhancing stability and security while maintaining efficiency of data storage is required.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention, which is contrived to solve the aforementioned problems, provides a data management apparatus and method for a block-chain-based distributed data storage system, capable of maintaining stability and security of the block-chain technique by applying the block-chain technique to data storage, maximizing efficiency and stability of data storage in a data storage apparatus to which the block-chain technique is applied, being environmentally-friendly because it does not require an excessive computing source in a proof method for storing data, maximizing fairness of storage by providing compensation depending on a contribution level for data storage and managing data storage independently and autonomously without requiring any operator intervention.

To solve the above problems, an aspect of the present invention features a data management apparatus for a block-chain-based distributed data storage system, including: a distributed data storage module configured to include two or more node storages connected with each other through a network including Internet and Ethernet and each including a local storage to store data; a data input/output status collection module configured to collect data input/output statuses with respect to the distributed data storage module; a contribution calculation module configured to calculate a contribution level of each node storage included in the distributed data storage module related to the data input/output through the statuses collected by the data input/output status collection module; a compensation module configured to perform compensation including a compensation target, a compensation amount, etc. in each node storage based on the compensation level of each node storage related to the data input/output calculated by the contribution calculation module.

The distributed data storage module may store a copy of the inputted data in two or more node storage included in the distributed data storage module

The data input/output status collection module may collect data input/output statuses including a data input/output frequency, an amount of input/output data, a total amount of stored data, and a data storage period in each node storage in the distributed data storage module.

The contribution calculation module may calculate a contribution level by assigning a weight value to information collected for efficient operation of a block-chain-based distributed data storage system for the statuses collected by the data input/output status collection module.

The compensation module may verify a validity of the data input/output statuses collected by the data input/output status collection module and performs compensation for a corresponding node storage included in the distributed data storage module depending on the contribution level calculated by the contribution calculation module, and then generates the validated data input/output status and the calculated contribution level and compensation history as blocks and stores them in each node storage.

To solve the above problems, an aspect of the present invention features a data management method for a block-chain-based distributed data storage system, including: inputting and storing data into a distributed data storage module configured to include two or more node storages connected with each other through a network including Internet and Ethernet and each including a local storage to store data, or reading and outputting data from a node storage in which the data is stored; collecting statuses in which data is inputted and stored or read out and outputted with respect to the distributed data storage module through a data input/output status collection module; calculating a contribution level of each node storage included in the distributed data storage module related to the data input/output through the statuses collected in the collecting; and performing compensation including a compensation target, a compensation amount, etc. in each node storage based on the compensation level of each node storage related to the data input/output calculated in the calculating.

In the inputting and storing or reading and outputting, same data as the inputted data may be stored in two or more node storages in the distributed data storage module.

In the collecting, the data input/output statuses may include a data input/output frequency, an amount of input/output data, a total amount of stored data, and a data storage period in each node storage in the distributed data storage module.

In the calculating, a contribution level may be calculated by assigning a weight value to information collected for efficient operation of a block-chain-based distributed data storage system for the statuses collected in the collecting.

The data management method may further include, in the performing, verifying a validity of the data input/output statuses collected in the collecting and performs compensation for a corresponding node storage included in the distributed data storage module depending on the contribution level calculated by the contribution calculation module, and generating the validated data input/output status and the calculated contribution level and compensation history as blocks and storing them in each node storage.

According to the exemplary embodiment of the present invention, it is possible to maintain stability and security of the block-chain technique by applying the block chain technique to the data storage.

In addition, efficiency and independence of data storage may be maximized in a data storage apparatus using the block chain technique.

In addition, it is environmentally-friendly because it does not require an excessive computing source in the proof method for storing data through the block, and it may maximize the fairness of the storage by providing compensation according to the contribution to the data storage.

In addition, stability and security of the block chain technique may be maintained in storing data, the data storage can be independently and autonomously managed without separate operator intervention.

### BRIEF DESCRIPTION OF THE DRAWINGS

FIG. 1 illustrates a schematic block diagram of a data management apparatus for a block-chain-based data storage system according to an exemplary embodiment of the present invention,

FIG. 2 illustrates a process of storing data in each node storage in the block-chain-based distributed data storage system according to an exemplary embodiment of the present invention,

FIG. 3 illustrates a process of controlling data stored in each node storage according to a status of the node storages in the block-chain-based distributed data storage system, and

FIG. 4 illustrates a flowchart for describing a data management method for a block-chain-based distributed data storage system according to an exemplary embodiment.

### DETAILED DESCRIPTION OF THE EMBODIMENTS

Hereinafter, a data management apparatus and method for a block-chain-based distributed data storage system according to an exemplary embodiment of the present invention will be described in detail with reference to the accompanying drawings.

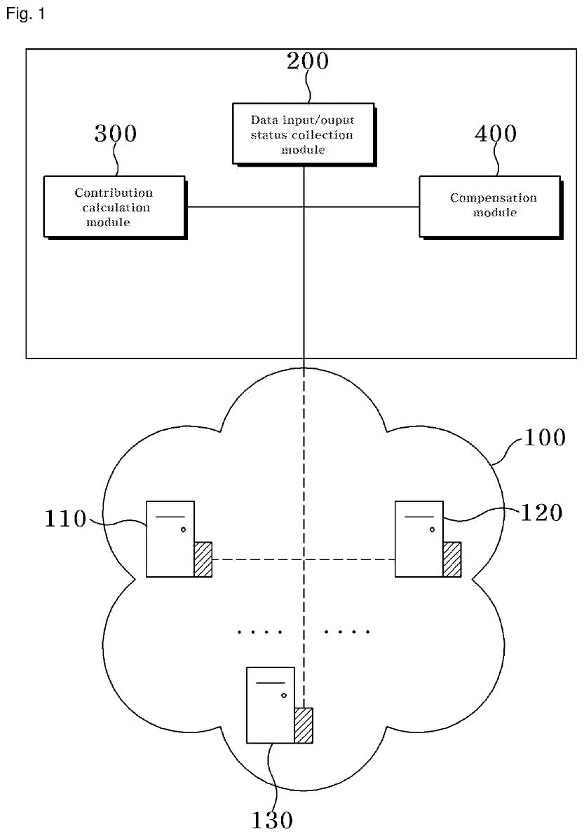

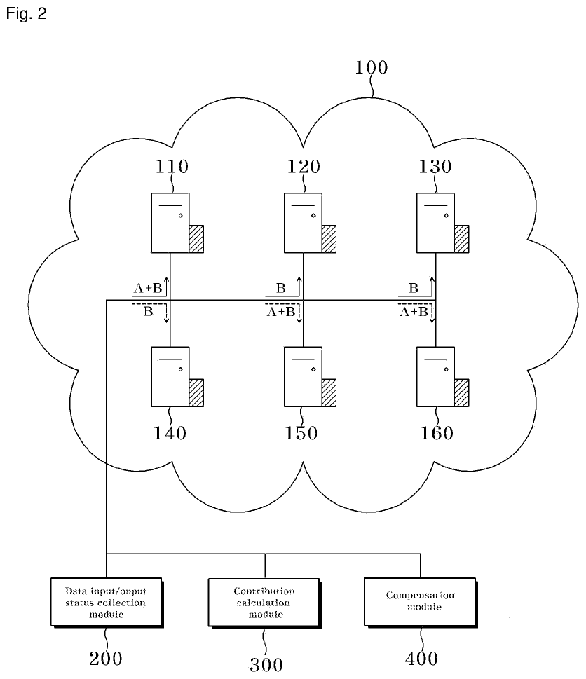

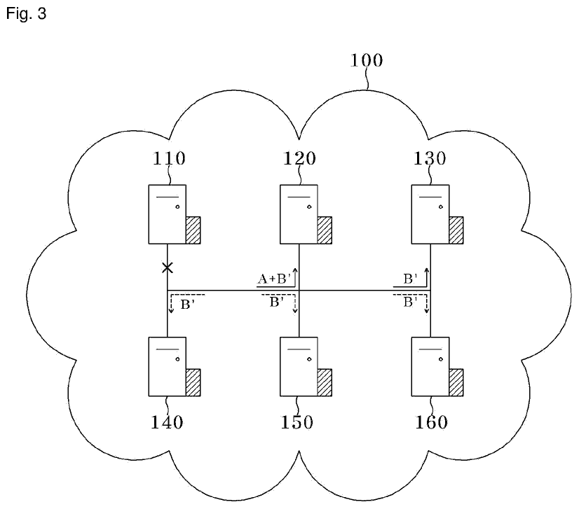

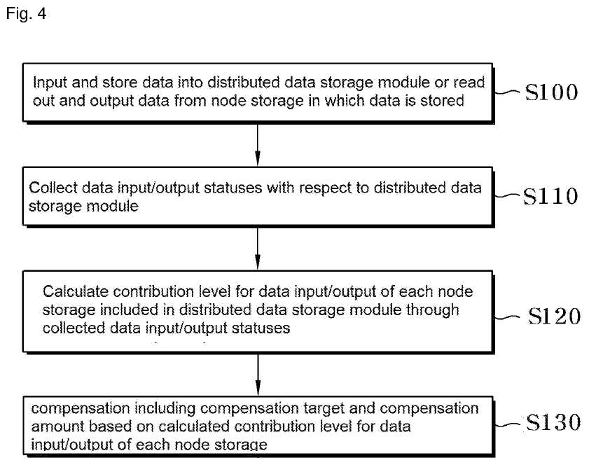

FIG. 1 illustrates a schematic block diagram of a data management apparatus for a block-chain-based data storage system according to an exemplary embodiment of the present invention, FIG. 2 illustrates a process of storing data in each node storage in the block-chain-based distributed data storage system according to an exemplary embodiment of the present invention, FIG. 3 illustrates a process of controlling data stored in each node storage according to a status of the node storages in the block-chain-based distributed data storage system, and FIG. 4 illustrates a flowchart for describing a data management method for a block-chain-based distributed data storage system according to an exemplary embodiment.

The data management apparatus and method for the block-chain-based distributed data storage system according to the present exemplary embodiment relate to a management apparatus and method that efficiently manage data of a block-chain-based distributed data storage system by collecting an output/input status of data in the data storage system to calculate a contribution level depending on the data input/output and thus perform appropriate compensation, instead of storing data by using a conventional large-capacity server.

As described above, the block-chain technique is advantageous in that data can be prevented from being corrupted or forged/falsified by modifying and restoring abnormal data through normal data stored in other node storages even when data stored in a node storage is corrupted or forged/falsified. Although the block chain technique has excellent data stability and security as described above, it has a disadvantage in that the efficiency of data storage is very low due to storing the same data in all nodes connected to the network. The present invention relates to an apparatus and a method that manage data such that compensation may be performed depending on data input/output and a contribution level thereof in a data storage system that can maximize an efficiency of data storage even when a large amount of data is stored while maintaining the stability and security of the block chain by overcoming such drawback of the block chain.

According to the present exemplary embodiment, the data management apparatus for the block-chain-based distributed data storage system includes a distributed data storage module 100 configured to include two or more node storages connected with each other through a network including Internet and Ethernet and each including a local storage to store data by combining the data with the block chain technique; a data input/output status collection module 200 configured to collect statuses related to data input and storage or output with respect to the distributed data storage module 100; a contribution calculation module 300 configured to calculate a contribution level by which each node storage 110 to 160 contributes to the data input/output based on the data collected by the data input/output status collection module 200, such as data input/output amounts, a data input/output frequency, a data storage period, etc.; and a compensation module 400 configured to perform compensation including a compensation target, a compensation amount, etc. in each node storage depending on the compensation level calculated by the contribution calculation module 300.

According to the present exemplary embodiment, the distributed storage module 100 is configured to store data in the data management apparatus. The distributed data storage module 100 may be formed to include two or more node storages 110 to 160 connected with each other through a network capable of transmitting/receiving data such as Internet or Ethernet, or may be formed to further include a distribution server (not illustrated) connected with each of the node storages 110 to 160 through a network. When the distribution server is further included, the distribution server is connected with each of the node storages 110 to 160 through a network, and each module necessary for driving the distributed data management apparatus is installed in the distribution server. One or more distribution server may be provided to perform efficient data input/output depending on the number of the node storages 110 to 160 connected thereto. In addition, when one or more distribution servers are provided, one of the distribution server may be configured to perform a supervisor function for road balancing of each of the distribution servers. The node storages 110 to 160 may be exemplified by a PC having a storage device such as an HDD or an SSD capable of storing data. The node storages 110 to 160 may be a personal computer or a server having a large capacity storage device.

As described above, the node storages 110 to 160 constituting the distributed data storage module 100 may be configured to be connected with each other through the Internet or Ethernet. Specifically, when they are connected with each other through the Internet, the data input/output is possible in the outside. When they are connected with each other through the Ethernet, access is possible only in the office or home and is difficult in the outside. Accordingly, it may be desirable to use it in a hospital, a company, or the like. Each of the node storages 110 to 160 has its own address regardless of the Internet or Ethernet. As a result, data is inputted/outputted by using an address assigned to each node storage.

When the distributed data storage module 100 is used in a company or a hospital, the node storages 110 to 160 may be provided at the company level or may be configured using company assets, but it may be efficient to use all or some personal computers in order to increase the utilization and a degree of freedom of the distributed data storage module 100.

A method of storing data based on the block chain technique in the distributed data storage module 100 will be described in detail. In a similar manner to a block-chain method, the distributed data storage module 100 distributes and stores same data in a predetermined number or more of the node storages 110 to 160. However, the data is not stored in all of the node storages 110 to 160 unlike the block-chain method, and the same data is stored in a certain number of node storages 110 to 160 and the number of node storages in which replicas of the same data are stored is managed. Security and stability may be maintained while eliminating waste of storage space such as a block chain by storing the data in this way. In addition, stability and security of data storage can be maintained high by storing a data storage status in a block and storing it in all nodes. For example, in the case that the copies are stored in three node storages, when a number of the node storages normally operated among the node storages in which the copies are stored is reduced to less than 3, the number of the node storages normally operated is maintained at 3 or more by replicating the data A to other node storages. Referring to FIG. 3, when some of the node storages 110 are not normally operated, the data A is stored in new node storages 120, and block data B′ obtained by updating the data related status is distributed and stored in all the node storages. In this way, the stability and security of data storage can be maintained by maintaining the number of normally operating node storages at a predetermined value or higher in any case. As described above, according to the present exemplary embodiment, the block-chained-based distributed data storage system stores data in a manner that is different from that of a conventional storage system using a large-capacity server, and thus it is necessary to manage the data accordantly. The present invention relates a data management apparatus that makes such data management more accurate and efficient.

The data input/output status collection module 200 is configured to collect statuses related to data input/output such as how much data and into which node storage is inputted and stored, what period of time data is stored, etc. when data is inputted/outputted with respect to the distributed data storage module 100. The data input/output status collection module 200 collects data on input/output frequency, amount of data, etc. from each node storage 110 to 160. Since the data input/output status collection module 200 collects a data input/output status and uses it as basic data for calculating a contribution level of each node storage 110-160, the collected may vary depending on the environment in which the data storage system according to the present exemplary embodiment is used without being limited to the above-mentioned items. For example, where storage of large capacity data is required, items related to data storage amounts and storage periods may be added, and where stability and security are more important, items may be added to determine the integrity of the data. In addition, the data input/output status collection module 200 may collect a CPU usage status of each node storage 110 to 160, a memory usage status thereof, a storage space usage status thereof, and a network usage status thereof. In this case, usage statuses of the CPU and the like are collected when the data input/output is performed according to the present exemplary embodiment. The four usage statuses are simple, and are used to grasp the contribution level most accurately.

In the present exemplary embodiment, the contribution calculation module 300 is configured to calculate a contribution level of each node storage 110 to 160 to the data storage system based on the statuses of the node storages 110 to 160, collected by the data input/output status collection module 200. The degree of contribution of each node storage to the data storage system may be calculated through various items such as a data input and output frequency, an input and output amount. However, as described above, it is possible to increase the efficiency of the data storage system and to have flexibility depending on the usage environment by assigning the weight value to each item in accordance with the environment in which the data storage system is utilized. For example, it may be preferable to perform evaluation mainly based on the data storage period in an environment where data needs to be stably managed for a long time, and it may be preferable to calculate a contribution level mainly based on the network connection period, the network stability, etc. in an environment where frequent input/output is required.

In the present exemplary embodiment, the compensation module 400 is configured to perform compensation by determining which node storage is compensated and how much level the compensation is made based on the contribution level of each node storage 110 to 160 calculated by the contribution calculation module 300. It may be preferable to perform the compensation by using crypto currency. This is because the data management apparatus according to the present exemplary embodiment may manage the data storage system to operate independently and autonomously without external intervention since the crypto currency is distributed in a digital form.

As the crypto currency is combined with compensation, it is necessary to connect a newly added block in order to operate the correct compensation and the data storage system based on the block chain. In this process, an agreement algorithm is required to determine a node storage with high contribution to be able to create a new block by referring to an input/output order and a position where the data is stored based on the data input/output status occurring between the node storages

According to a conventional method, this agreement algorithm was quickly determined or determined according to equity, which may lead to excessive resource consumption and unfairness as described above. According to the present exemplary embodiment, the agreement algorithm may be operated fairly and environmentally-friendly depending on the contribution levels. In addition, the agreement algorithm based on the contribution level may be applied to the data storage system as in the present invention, but it may be extended to a circulation process of the crypto currency, thereby contributing to the fair and reasonable use of the crypto currency.

A data management method for a block-chain-based distributed data storage system according to an exemplary embodiment of the present invention will be described with reference to FIG. 4, and a duplicated description will be omitted.

According to the present exemplary embodiment, the data management method for a block-chain-based distributed data storage system may include inputting and outputting data with respect to the distributed data storage module 100 configured to include two or more node storages connected with each other through a network including Internet and Ethernet and each including a local storage to store data (S100); collecting a data input/output status through the data input/output status collection module 200 in the process of inputting and outputting the data with respect to the distributed data storage module 100 (S110); calculating a contribution level of each node storage 110 to 160 after the status is collected (S120); and performing compensation for each node storage 110 to 160 based on the calculated contribution levels (S130).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

distributed data storage module: 100

data input/output status collection module: 200

contribution calculation module: 300 compensation module: 400

What is claimed is:

1. A data management apparatus for a block-based distributed data storage system, the apparatus comprising:
a distributed data storage module configured to include two or more node storages connected with each other through a network including Internet and Ethernet and each including a local storage to store data;
a data input/output status collection module configured to collect data input/output statuses with respect to the distributed data storage module;
a contribution calculation module configured to calculate a contribution level of each node storage included in the distributed data storage module related to the data input/output through the statuses collected by the data input/output status collection module;
a compensation module configured to perform compensation including a compensation target, a compensation amount, etc. in each node storage based on the compensation level of each node storage related to the data input/output calculated by the contribution calculation module.

2. The data management apparatus of claim 1, wherein
the distributed data storage module stores a copy of the inputted data in two or more node storage included in the distributed data storage module.

3. The data management apparatus of claim 1, wherein
the data input/output status collection module collects data input/output statuses including a data input/output frequency, an amount of input/output data, a total amount of stored data, and a data storage period in each node storage in the distributed data storage module.

4. The data management apparatus of claim 3, wherein
the contribution calculation module calculates a contribution level by assigning a weight value to information collected for efficient operation of a block-chain-based distributed data storage system for the statuses collected by the data input/output status collection module.

5. The data management apparatus of claim 1, wherein
the compensation module verifies a validity of the data input/output statuses collected by the data input/output status collection module and performs compensation for a corresponding node storage included in the distributed data storage module depending on the contribution level calculated by the contribution calculation module, and then generates the validated data input/output status and the calculated contribution level and compensation history as blocks and stores them in each node storage.

6. A data management method for a block-based distributed data storage system, the method comprising:
inputting and storing data into a distributed data storage module configured to include two or more node storages connected with each other through a network including Internet and Ethernet and each including a local storage to store data, or reading and outputting data from a node storage in which the data is stored;
collecting statuses in which data is inputted and stored or read out and outputted with respect to the distributed data storage module through a data input/output status collection module;
calculating a contribution level of each node storage included in the distributed data storage module related to the data input/output through the statuses collected in the collecting; and
performing compensation including a compensation target, a compensation amount, etc. in each node storage based on the compensation level of each node storage related to the data input/output calculated in the calculating.

7. The data management method of claim 6, wherein
in the inputting and storing or reading and outputting,
same data as the inputted data is stored in two or more node storages in the distributed data storage module.

8. The data management method of claim 6, wherein
in the collecting,
the data input/output statuses include a data input/output frequency, an amount of input/output data, a total amount of stored data, and a data storage period in each node storage in the distributed data storage module.

9. The data management method of claim 8, wherein
in the calculating,
a contribution level is calculated by assigning a weight value to information collected for efficient operation of a block-chain-based distributed data storage system for the statuses collected in the collecting.

10. The data management method of claim 6, further comprising:
in the performing,
verifying a validity of the data input/output statuses collected in the collecting and performing compensation for a corresponding node storage included in the distributed data storage module depending on the contribution level calculated by the contribution calculation module, and generating the validated data input/output status and the calculated contribution level and compensation history as blocks and storing them in each node storage.
